(19) United States
(12) Patent Application Publication
(10) Pub. No.: US 2007/0251939 A1
(43) Pub. Date: Nov. 1, 2007

(54) Control scheme for cold wafer compensation on a lithography track

(75) Inventors: Alex Minkovich, Campbell, CA (US); Natarajan Ramanan, San Jose, CA (US); Eehern Wong, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 11/414,138

(22) Filed: Apr. 27, 2006

(51) Int. Cl. H05B 1/02

(52) U.S. Cl. 219/505

(57) ABSTRACT

The present invention relates generally to control schemes for controlling the temperature of a heater plate of a thermal unit, e.g., of a track lithography tool. In accordance with certain embodiments of the invention, a cold wafer compensation offset value is added to an initial target heater plate temperature setpoint, and this setpoint plus offset is used to control the temperature of the heater plate prior to placement of a semiconductor wafer, e.g., via Proportional-Integral-Derivative (PID) control. Further, in accordance with certain embodiments, upon cold wafer placement, the temperature control is turned off until the temperature of the heater plate reaches the initial target heater plate temperature setpoint. The temperature control (e.g., PID control) is then reinstated, and the heater plate and wafer are controlled to steady state. In other embodiments, the control schemes of the invention include an integral contribution memory component prior to cold wafer placement, which reinstates the same integral contribution value once PID temperature control is turned back on.

### BACKGROUND OF THE INVENTION

The present invention relates generally to the field of substrate processing equipment. More particularly, the present invention relates to a control scheme for temperature control of thermal units of semiconductor substrate processing equipment.

Modern integrated circuits contain millions of individual elements that are formed by patterning the materials, such as silicon, metal and/or dielectric layers, which make up the integrated circuit, to sizes that are small fractions of a micrometer. The technique used throughout the industry for forming such patterns is photolithography. A typical photolithography process sequence generally includes depositing one or more uniform photoresist (resist) layers on the surface of a substrate, drying and curing the deposited layers, patterning the substrate by exposing the photoresist layer to electromagnetic radiation that is suitable for modifying the exposed layer, and then developing the patterned photoresist layer.

It is common in the semiconductor industry for many of the steps associated with the photolithography process to be performed in a multi-chamber processing system (e.g., a cluster tool) that has the capability to sequentially process semiconductor wafers in a controlled manner. One example of a cluster tool that is used to deposit (i.e., coat) and develop a photoresist material is commonly referred to as a track lithography tool.

Track lithography tools typically include a mainframe that houses multiple chambers (which are sometimes referred to herein as stations) dedicated to performing the various tasks associated with pre- and post-lithography processing. There are typically both wet and dry processing chambers within track lithography tools. Wet chambers include coat and/or develop bowls, while dry chambers include thermal control units that house bake and/or chill plates. Track lithography tools also frequently include one or more pod/cassette mounting devices, such as an industry standard FOUP (front opening unified pod), to receive substrates from and return substrates to the clean room, multiple substrate transfer robots to transfer substrates between the various chambers/stations of the track tool, and an interface that allows the tool to be operatively coupled to a lithography exposure tool in order to transfer substrates into the exposure tool and receive substrates from the exposure tool after the substrates are processed within the exposure tool.

Often, lithography wafers are processed at varying temperatures throughout a lithography track, and various chambers within a lithography track are used for processes at varying temperatures. However, traditional temperature control schemes have a shortcoming that result in limitations, e.g., steady state temperature control.

### BRIEF SUMMARY OF THE INVENTION

In part to address such shortcomings, in a first aspect the present invention provides a control unit for controlling the temperature of a heater plate of a semiconductor processing thermal unit. The control unit includes a control module interfaced with a heater plate of a semiconductor processing thermal unit, wherein the control module is configured to implement a temperature control scheme including cold wafer temperature compensation. In certain embodiments, the control unit is configured to obtain steady state temperature control of the heater plate at the desired heater plate temperature setpoint following placement of a semiconductor wafer in less than about 60 seconds.

The temperature control scheme includes: controlling the heater plate temperature based on a desired heater plate temperature setpoint plus a predetermined cold wafer compensation offset value; turning off control upon placement of a semiconductor wafer on the heater plate until the temperature of the heater plate reaches the desired heater plate temperature setpoint; reinstating control and controlling the heater plate temperature at the desired heater plate temperature setpoint for a desired duration of time.

In certain embodiments, the control unit is a Proportional-Integral-Derivative (PID) control unit, and the temperature control scheme further includes: retaining the integral contribution value of the PID control prior to placement of the semiconductor wafer, and reinstating the same integral contribution value when PID control is turned back on to control at the desired heater plate temperature setpoint. The integral contribution value may optionally be retained based on the value attained during steady state control of the desired heater plate temperature setpoint without the cold wafer compensation offset value.

In another aspect of the invention, a lithography track tool is also provided. The lithography track tool includes: a semiconductor processing thermal unit including a heather plate interfaced with a control unit for controlling the temperature of the heater plate. The control unit comprises a control module interfaced with the heater plate configured to implement a temperature control scheme including cold wafer temperature compensation, as described herein.

In yet another aspect of the invention, a method for controlling the temperature of a heater plate of a semiconductor processing thermal unit, as described herein, is provided.

In yet another aspect of the invention, a control unit for controlling the temperature of a heater plate of a semiconductor processing thermal unit is provided. The control unit includes a control module interfaced with a heater plate of a semiconductor processing thermal unit. The control module is configured to implement a temperature control scheme including cold wafer temperature compensation.

Again, the temperature control scheme includes: controlling the heater plate temperature based on a desired heater plate temperature setpoint plus a predetermined cold wafer compensation offset value; turning off control upon placement of a semiconductor wafer on the heater plate until the temperature of the heater plate reaches the desired heater plate temperature setpoint; reinstating control and controlling the heater plate temperature at the desired heater plate temperature setpoint for a desired duration of time.

These and other aspects of the invention will be described in more detail throughout the present specification and more particularly below in conjunction with the following drawings.

### BRIEF DESCRIPTION OF THE DRAWINGS

FIG. 1 is a simplified plan view of an embodiment of a track lithography tool according to an embodiment of the present invention;

FIG. 2 is a top view of a heater plate useful in connection with the control schemes of the present invention;

FIGS. 3A and 3B illustrate a comparison of control without (FIG. 3A) and with (FIG. 3B) cold wafer compensation according to embodiments of the present invention;

FIG. 4 illustrates an exemplary control system in accordance with embodiments of the present invention;

FIGS. 5A and 5B illustrate an exemplary control scheme of one embodiment of the invention (FIG. 5A) and a graph illustrating exemplary trigger points of FIG. 5A (FIG. 5B);

FIG. 6 illustrates a method in accordance with certain embodiments of the invention;

FIGS. 7A and 7B illustrate a comparison of control without (FIG. 7A) and with (FIG. 7B) integral memory according to embodiments of the present invention.

### DETAILED DESCRIPTION OF THE INVENTION

According to the present invention, techniques related to the field of substrate processing equipment are provided. Several problems exist today with the control of temperature of heater plates of thermal units in semiconductor processing, particularly multizone heater plates with independently controlled zones. For example, when the heater plate has reached a steady state temperature and a cold wafer is placed upon it, the plate transfers a large quantity of heat to the wafer in a short period of time and therefore cools down by a few degrees. Current control schemes then generally overcompensate for the loss in temperature and greatly overshoot the setpoint temperature. In part to address such issues, the present invention provides improved control schemes. The control schemes can be applied to any bake processes for semiconductor substrates, for example those used in pre-exposure bake processing, post-exposure bake processing, post-resist bake processing, etc.

I. Track Lithography Tool

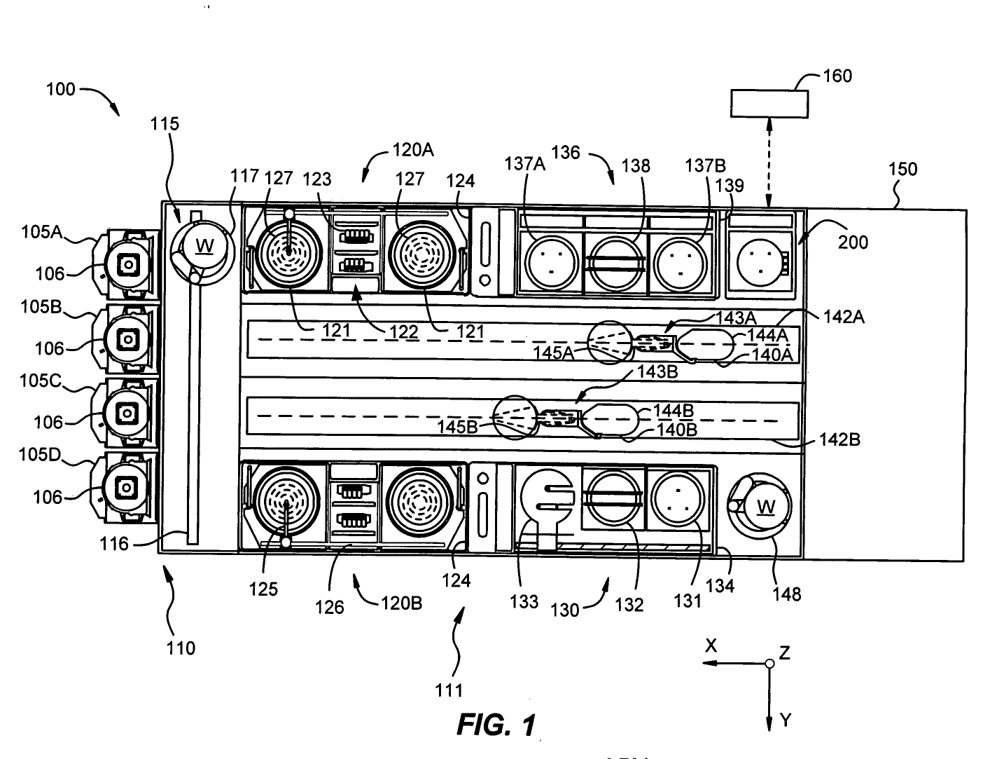

By way of background, FIG. 1 is a plan view of an embodiment of a track lithography tool 100 in which the embodiments of the present invention may be used. As illustrated in FIG. 1, track lithography tool 100 contains a front end module 110 (sometimes referred to as a factory interface or FI) and a process module 111. In other embodiments, the track lithography tool 100 includes a rear module (not shown), which is sometimes referred to as a scanner interface. Front end module 110 generally contains one or more pod assemblies or FOUPS (e.g., items 105A-D) and a front end robot assembly 115 including a horizontal motion assembly 116 and a front end robot 117. The front end module 110 may also include front end processing racks (not shown). The one or more pod assemblies 105A-D are generally adapted to accept one or more cassettes 106 that may contain one or more substrates or wafers, “W,” that are to be processed in track lithography tool 100. The front end module 110 may also contain one or more pass-through positions (not shown) to link the front end module 110 and the process module 111.

Process module 111 generally contains a number of processing racks 120A, 120B, 130, and 136. As illustrated in FIG. 1, processing racks 120A and 120B each include a coater/developer module with optional shared dispense 124. A coater/developer module with shared dispense 124 includes two coat bowls 121 positioned on opposing sides of a shared dispense bank 122, which contains a number of nozzles 123 providing processing fluids (e.g., bottom anti-reflection coating (BARC) liquid, resist, developer, and the like) to a wafer mounted on a substrate support 127 located in the coat bowl 121. In the embodiment illustrated in FIG. 1, a dispense arm 125 sliding along a track 126 is able to pick up a nozzle 123 from the shared dispense bank 122 and position the selected nozzle over the wafer for dispense operations. Of course, coat bowls with dedicated dispense banks are provided in alternative embodiments.

Processing rack 130 includes an integrated thermal unit 134 including a bake plate 131, a chill plate 132, and a shuttle 133. The bake plate 131 and the chill plate 132 are utilized in heat treatment operations including post exposure bake (PEB), post-resist bake, and the like. In some embodiments, the shuttle 133, which moves wafers in the x-direction between the bake plate 131 and the chill plate 132, is chilled to provide for initial cooling of a wafer after removal from the bake plate 131 and prior to placement on the chill plate 132. Moreover, in other embodiments, the shuttle 133 is adapted to move in the z-direction, enabling the use of bake and chill plates at different z-heights. Processing rack 136 includes an integrated bake and chill unit 139, with two bake plates 137A and 137B served by a single chill plate 138.

One or more robot assemblies (robots) 140 are adapted to access the front-end module 110, the various processing modules or chambers retained in the processing racks 120A, 120B, 130, and 136, and the scanner 150. By transferring substrates between these various components, a desired processing sequence can be performed on the substrates. The two robots 140 illustrated in FIG. 1 are configured in a parallel processing configuration and travel in the x-direction along horizontal motion assembly 142. Utilizing a mast structure (not shown), the robots 140 are also adapted to move in a vertical (z-direction) and horizontal directions, i.e., transfer direction (x-direction) and a direction orthogonal to the transfer direction (y-direction). Utilizing one or more of these three directional motion capabilities, robots 140 are able to place wafers in and transfer wafers between the various processing chambers retained in the processing racks that are aligned along the transfer direction.

Referring to FIG. 1, the first robot assembly 140A and the second robot assembly 140B are adapted to transfer substrates to the various processing chambers contained in the processing racks 120A, 120B, 130, and 136. In one embodiment, to perform the process of transferring substrates in the track lithography tool 100, robot assembly 140A and robot assembly 140B are similarly configured and include at least one horizontal motion assembly 142, a vertical motion assembly 144, and a robot hardware assembly 143 supporting a robot blade 145 robot assemblies 140 are in communication with a system controller 160. In the embodiment illustrated in FIG. 1, a rear robot assembly 148 is also provided.

The scanner 150, which may be purchased from Canon USA, Inc. of San Jose, Calif., Nikon Precision Inc. of Belmont, Calif., or ASML US, Inc. of Tempe Ariz., is a lithographic projection apparatus used, for example, in the manufacture of integrated circuits (ICs). The scanner 150 exposes a photosensitive material (resist), deposited on the substrate in the cluster tool, to some form of electromagnetic radiation to generate a circuit pattern corresponding to an individual layer of the integrated circuit (IC) device to be formed on the substrate surface.

Each of the processing racks 120A, 120B, 130, and 136 contain multiple processing modules in a vertically stacked arrangement. That is, each of the processing racks may contain multiple stacked coater/developer modules with shared dispense 124, multiple stacked integrated thermal units 134, multiple stacked integrated bake and chill units 139, or other modules that are adapted to perform the various processing steps required of a track photolithography tool. As examples, coater/developer modules with shared dispense 124 may be used to deposit a bottom antireflective coating (BARC) and/or deposit and/or develop photoresist layers. Integrated thermal units 134 and integrated bake and chill units 139 may perform bake and chill operations associated with hardening BARC and/or photoresist layers after application or exposure.

In one embodiment, a system controller 160 is used to control all of the components and processes performed in the cluster tool 100. The controller 160 is generally adapted to communicate with the scanner 150, monitor and control aspects of the processes performed in the cluster tool 100, and is adapted to control all aspects of the complete substrate processing sequence. The controller 140, which is typically a microprocessor-based controller, is configured to receive inputs from a user and/or various sensors in one of the processing chambers and appropriately control the processing chamber components in accordance with the various inputs and software instructions retained in the controller's memory. The controller 140 generally contains memory and a CPU (not shown) which are utilized by the controller to retain various programs, process the programs, and execute the programs when necessary. The memory (not shown) is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits (not shown) are also connected to the CPU for supporting the processor in a conventional manner. The support circuits may include cache, power supplies, clock circuits, input/output circuitry, subsystems, and the like all well known in the art. A program (or computer instructions) readable by the controller 140 determines which tasks are performable in the processing chamber(s). Preferably, the program is software readable by the controller 160 and includes instructions to monitor and control the process based on defined rules and input data.

It is to be understood that embodiments of the invention are not limited to use with a track lithography tool such as that depicted in FIG. 1. Instead, embodiments of the invention may be used in any track lithography tool including the many different tool configurations described in U.S. patent application Ser. No. 11/315,984, entitled “Cartesian Robot Cluster Tool Architecture” filed on Dec. 22, 2005, which is hereby incorporated by reference for all purposes and including configurations not described in the above referenced application.

II. Control Schemes

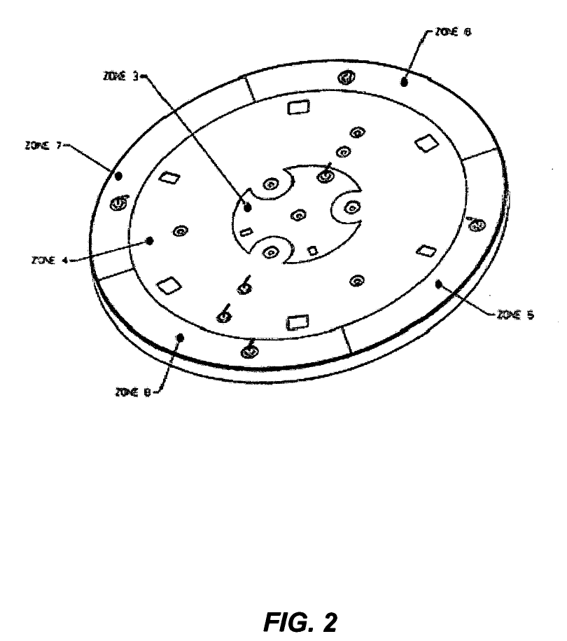

More specifically, the present invention relates generally to control schemes for controlling the temperature of a heater plate of a thermal unit, e.g., as described above with reference to the track lithography tool. The thermal unit may be an integrated heat/cool thermal unit, or may be a stand alone bake chamber. The control schemes of the present invention are particularly suited for controlling the temperature of multizone heater plates, such as the heater plate shown in FIG. 2. However, the present invention is not limited in any regard to the specific configuration of the heater plate illustrated in FIG. 2.

By way of example, the heater plate may have one, two, three, four, five, six, etc. heating zones, which may each be independently controlled according to the control schemes of the present invention. For instance, with reference to FIG. 2, zones 3, 4, 5, 6, 7, and 8 may each be independently controlled. Alternatively, various heating zones may be controlled as units. For instance, with reference to FIG. 2, exterior edge zones 5-8 may be controlled together as a unit, while interior zones 3 and 4 may be controlled together as a unit.

The control schemes of the invention may be implemented via any suitable control unit known in the art. Such control units are typically microprocessor-based, and are configured to receive inputs from a user and/or various sensors to appropriately control, e.g., the temperature of the heater plate (and thereby a semiconductor wafer) in accordance with the various inputs and software instructions retained in the control unit's memory. The control unit will generally include memory and a CPU which are utilized by the control unit to retain various programs, process the programs, and execute the programs when necessary. The memory is connected to the CPU, and may be one or more of a readily available memory, such as random access memory (RAM), read only memory (ROM), floppy disk, hard disk, or any other form of digital storage, local or remote. Software instructions and data necessary, e.g., to implement the control schemes described herein, may be coded and stored within the memory for instructing the CPU. The support circuits may also be connected to the CPU for supporting the processor in a conventional manner. The support circuits may include cache, power supplies, clock circuits, input/output circuitry, subsystems, and the like all well known in the art.

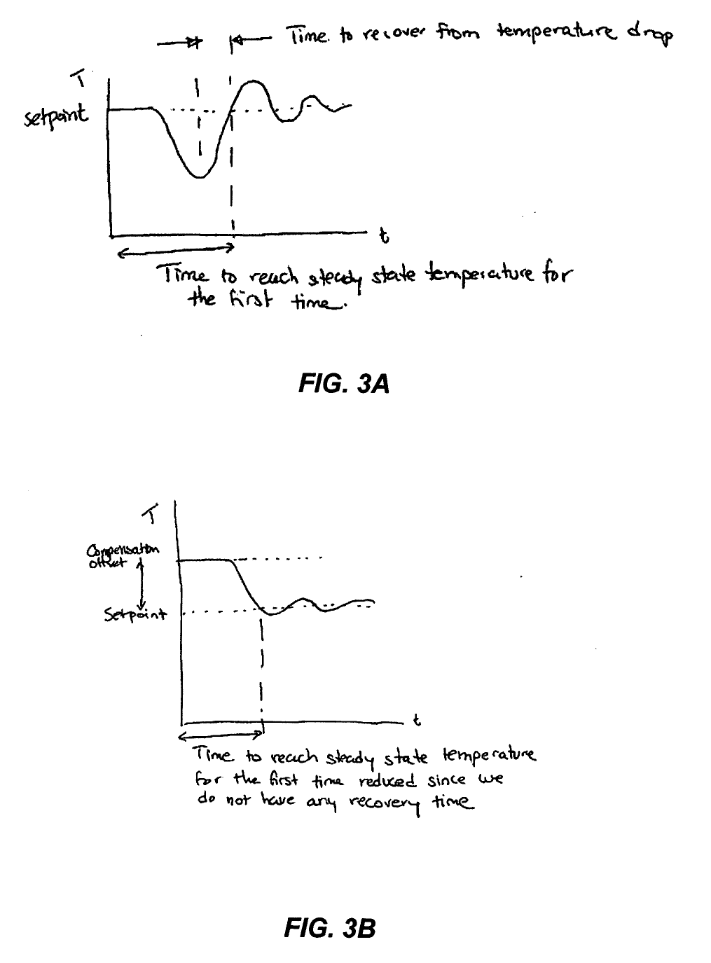

In certain aspects of the invention, the control schemes are configured to reach steady state temperature control in the least amount of time and the least transient temperature non uniformity. As described above, when a semiconductor wafer is initially placed on the heater plate, a large amount of energy (and heat) is transferred from the plate to the wafer. If the heater plate temperature is not controlled at a temperature above the actual desired temperature setpoint of the bake processing operation before placement of the cold wafer, reaching the desired temperature setpoint requires additional energy and time (see FIG. 3A).

To compensate for this “cold wafer” effect, the amount of heat transferred from the heater plate to the wafer during heat-up and what change in heater plate temperature this translates to was estimated. The initial heater plate temperature setpoint may then be adjusted based on this “cold wafer compensation offset value.” More particularly, in accordance with certain embodiments of the invention, the cold wafer compensation offset value is added to the initial target heater plate temperature setpoint, and this setpoint plus offset is used to control the temperature of the heater plate prior to placement of the cold wafer, e.g., via Proportional-Integral-Derivative (PID) control, Proportional-only control, other non-PID control, etc. Further, in accordance with certain embodiments, upon cold wafer placement, the temperature control is turned off until the temperature of the heater plate reaches the initial target heater plate temperature setpoint. The temperature control (e.g., PID control, non-PID control, etc.) is then reinstated, and the heater plate and wafer are controlled to steady state (FIG. 3B). This effectively eliminates the additional time previously required to heat up both heater plate and wafer to the desired temperature.

In other aspects, e.g., when PI or PID control is used, in order to minimize the time required from when the wafer first crosses the desired heater plate temperature setpoint, to when the wafer reaches steady state temperature, the present invention includes integral contribution memory. Without intending to be limited by memory, because the temperature (RTD) sensors in the heater plate are located closer to the heating material than the wafer, the wafer's response can be estimated as a delayed version of the RTD response. Minimizing overshoot on the heater plate RTD decreases the time required to reach steady state on the heater plate, and therefore on the wafer. In non-integral contribution memory control, the reason for overshoot in the heater plate response can generally be attributed to time it takes for the integral error to accrue back to its steady state condition after temperature control is turned back on.

As such, in certain aspects, the control schemes of the invention include an integral contribution memory component prior to cold wafer placement, which reinstates the same integral contribution value once, e.g., PID temperature control is turned back on. As used herein with reference to aspects of the invention related to integral memory, reference may be made to PID control. However, the invention is not so limited and any known control strategy with integral action may be used, including by not limited to Proportional-Integral (PI) control. In accordance with this aspect of the invention, the integral memory eliminates the learning time previously needed to calculate the steady state integral contribution. In certain embodiments, the integral contribution may be retained and based on the integral contribution value needed during steady state operation at target heater plate temperature setpoint rather than target temperature setpoint plus cold wafer compensation offset. In such embodiments, the amount necessary may be determined by a calibration plot mapping steady state temperature to integral contribution to output power. By way of example, with no integral memory, when the PID control is reactivated, it takes approximately 60 seconds to stabilize. However, with integral memory, the controlled temperature zone stabilizes essentially instantaneously. The overshoot is 4 times smaller, and settling time also approximately 4 times faster.

In yet another aspect, the control schemes of the invention are configured to maximize uniformity across the wafer and heater plate during the heating period of the wafer up to the desired steady state temperature setpoint. In this regard, the control schemes of the invention are particularly suited for multizone heater plates, which allow for additional control over temperature uniformity using the control schemes described herein. More particularly, by way of example, controlling each zone of a multizone heater plate independently with the control schemes of the invention improves plate uniformity in that output power and timing are independently controlled for each zone.

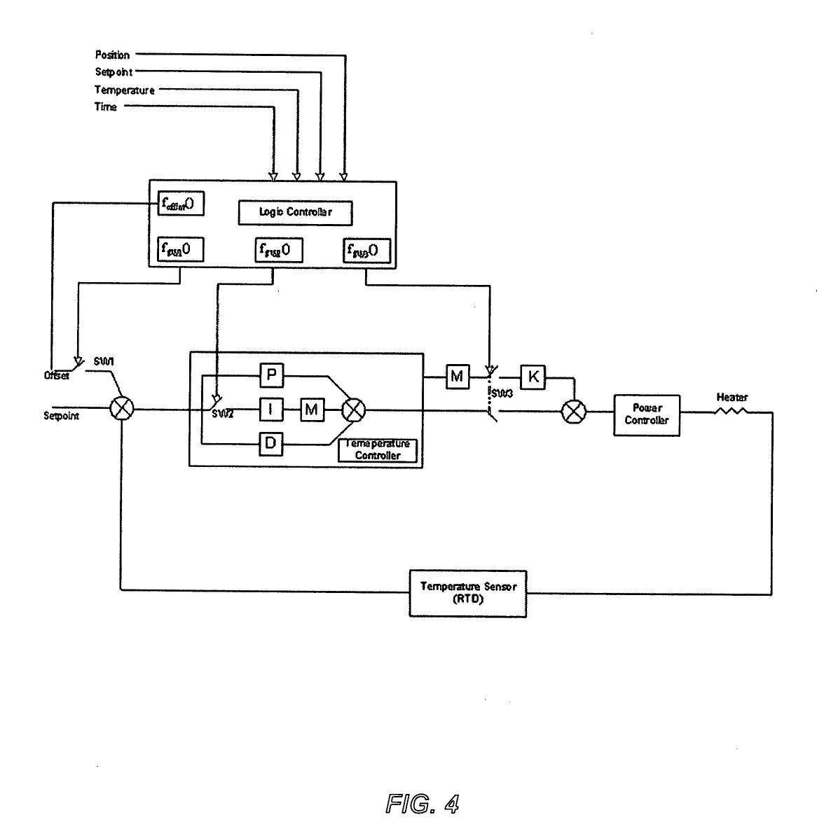

Turning now to FIG. 4, an exemplary control system 400 in accordance with certain aspects of the present invention is illustrated. The illustrated control system 400 includes a control module 402 that interfaces with the heater plate and receives inputs 404, e.g., from temperature sensor(s) 406. Based in part on inputs 404, the control module 402 calculates temperature offset, and controls three logic switches (SW1, SW2, and SW3) for each individual heater zone to be controlled (or the entire heater plate if desired or a single zone heater plate). In the figure, Offset=f(Wafer Material, Plate Material, Target Setpoint, Room Temperature); SW1=f(Plate Position, Temperature, Setpoint, Time); SW2=f(Plate Position, Temperature, Setpoint, Time); and SW3=f(Plate Position, Temperature, Setpoint, Time).

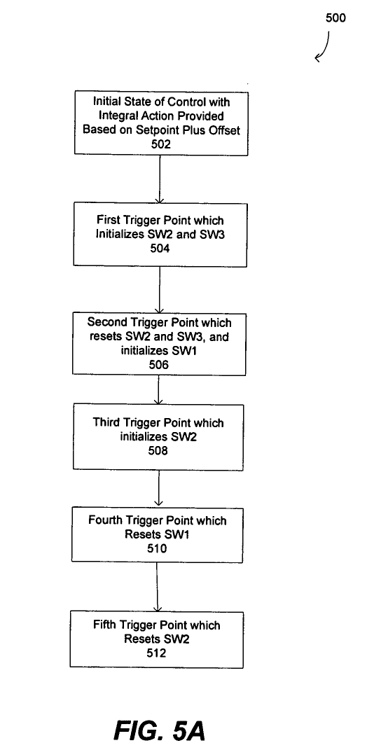

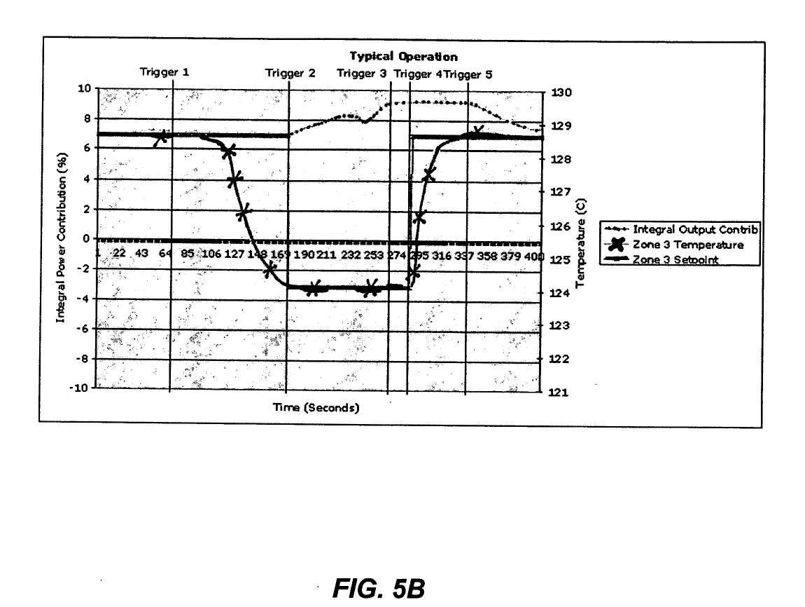

With reference to FIGS. 5A and 5B, in one embodiment, five exemplary triggers of the control system of FIG. 4 are illustrated. With reference to FIG. 5A, control scheme 500 is provided included an initial state, three logic switches, and five trigger points of the logic switches. FIG. 5B then graphically illustrates the various exemplary trigger points of method 500. At step 502, an initial state of control with integral action, e.g., PI or PID control, is provided at a desired heater plate temperature setpoint (e.g., 124.1° C.) plus a predetermined cold wafer compensation offset value (e.g., 4.53° C. to equal 128.63° C.) based on a compensation value for the average temperature difference between the heater plate temperature setpoint and the initial temperature of a semiconductor wafer that is to be heated by the heater plate.

Continuing to step 504, a first trigger point is provided at a time point based upon contact of a semiconductor wafer to the heating plate, which initializes switch-two and switch-three. Switch-two prompts the control module to turn off PID control to the heater plate while retaining the integral contribution in memory and wherein switch-three prompts the control module to retain the output power contribution in memory and to manually set the output power of the control module for the heater plate to the retained value times an optional predetermined scaling factor.

By way of example, the scaling factor is generally a function of offset and environmental heat losses. In accordance with certain embodiments of the invention, although the offset may be calculated as the total energy needed to increase wafer temperature to process temperature, the contribution from the offset may be decreased by using a lower offset, and this deficiency may be optionally supplemented with a scaling factor to the manual heater output. Thus, the total energy from the offset in the plate, plus the additional power from the heater during the transient time, equals total energy needed to increase wafer temperature to process temperature. This additional degree of freedom in the scaling factor allows for tuning of the transient time of the control loop.

At step 506, a second trigger point is provided at a time point based on when the heater plate temperature reaches the desired temperature setpoint plus an optional predetermined temperature drift offset, which resets switch-two and switch-three so as to prompt the control module to turn PID control on with the retained integral contribution value and to switch the output power back from manual, and further initializes switch-one. Switch-one prompts the control module to remove the predetermined cold wafer compensation offset value from the desired temperature setpoint of the heater plate. The optional predetermined temperature drift offset may be used to accommodate controller tuning. Without intending to be limited by theory, the heat transfer model of a multizone heater plate may differ from heater zone to heater zone, and because of zone to zone coupling, zones cool at different speeds. By reinstating control at different temperature drift offsets, this allows for compensation of zone to zone differences in heat transfer.

A third trigger point is provided at step 508 at a time based on when the semiconductor wafer is removed from the heater plate, which again initializes switch-two so as to prompt the control module latch the integral contribution value to generally result in PD control with some offset power.

Step 510 provides a fourth trigger point at a time after the semiconductor wafer is removed from the heater plate, which resets switch-one so as to prompt the control module to reinstate the predetermined cold wafer compensation offset value to the desired temperature setpoint of the heater plate.

Step 512 then provides a fifth trigger point at a time after the heater plate temperature reaches the desired temperature setpoint, plus the predetermined cold wafer compensation offset value, plus an optional predetermined temperature drift offset, which resets switch-two so as to prompt the control module to reset the integral contribution value to result in PID control. Again, the optional predetermined temperature drift offset may be used if desired.

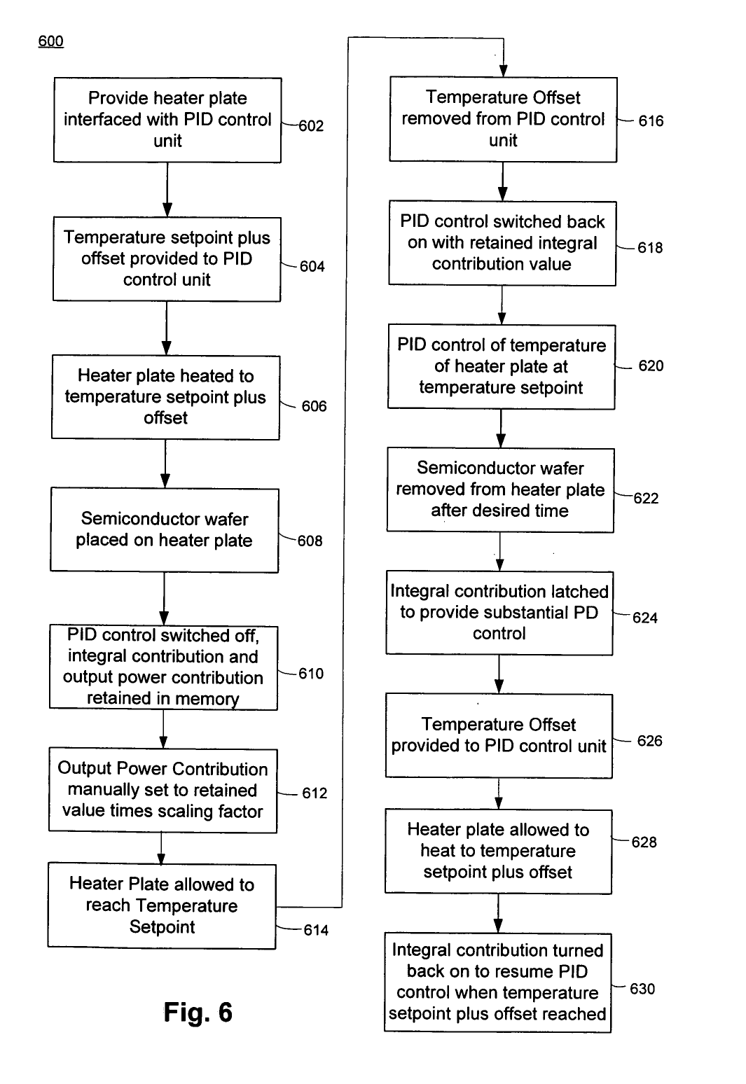

In one particular embodiment of the invention, a method for controlling the temperature of a heater plate of a semiconductor thermal unit (and as such a semiconductor wafer) using a control scheme of the invention is provided. With reference to FIG. 6, method 600 is illustrated, wherein at step 602, a heater plate is provided which is interfaced with a PID control unit configured to control the temperature of the heater plate. At step 604, a desired temperature setpoint plus a predetermined cold wafer compensation offset value based on a compensation value for the average temperature difference between the heater plate temperature setpoint and the initial temperature of a semiconductor wafer that is to be heated by the heater plate is provided to the PID control unit. Then, at step 606, the heater plate is heated to the desired temperature setpoint plus the predetermined cold wafer compensation offset value.

A semiconductor wafer is then placed on the heater plate at step 608 after the heater plate has reached the desired temperature setpoint plus predetermined cold wafer compensation offset value. Continuing to step 610, the PID control unit is switched off, and the integral contribution and the output power contribution of the PID control unit are retained in memory in the PID control unit. The output power contribution of the control unit is then manually set to the retained value times a predetermined scaling factor at step 612.

At step 614, the heater plate is allowed to reach the desired setpoint temperature plus an optional predetermined temperature drift offset, and the predetermined cold wafer compensation offset value is removed from the temperature setpoint of the PID control unit at step 616. The PID control unit is then switched on with the retained integral contribution utilized by the PID control unit, and the output power contribution switched from manual mode at step 618. At step 620, the PID control unit is allowed to control the temperature of the heater plate (and thus the semiconductor wafer) at the desired temperature setpoint for a desired amount of time.

After the desired amount of time, the semiconductor wafer is removed from the heater plate at step 622, and the integral contribution of the PID control unit is latched so as to provide substantial PD control with power offset at step 624. The predetermined cold wafer compensation offset value is then provided to the PID control unit to adjust the desired temperature setpoint at step 626, and the heater plate is allowed to heat to the desired temperature setpoint plus the predetermined cold wafer compensation offset value at step 628. The integral contribution of the PID control unit is then switched back on after the heater plate has reached the desired temperature setpoint plus predetermined cold wafer compensation offset value at step 630.

### EXAMPLES

The following examples are provided to illustrate how the general faceplate and systems described in connection with the present invention may be used rapid temperature equilibration. However, the invention is not limited by the described examples.

Calculation of Cold Wafer Compensation Temperature Offset:

In accordance with the control schemes of the invention, the loss in temperature of the heater plate due to the placement of a cold wafer is estimated to provide a value for the cold wafer compensation offset. By way of example, an aluminum heater plate with a desired temperature setpoint of 125° C. and a silicon wafer with an initial temperature of 22° C. were assumed.
Al heater plate: mass=2.038 kg
Si wafer: mass=0.115 kg
Al specific heat capacity=900 J/(kg-K)
Si specific heat capacity=700 J/(kg-K)
Target heater plate/wafer temperature=125 C
Room temperature=22 C
Change in Si wafer temperature=125 C-22 C=103 C=103 K
Heat gained by Si wafer=700 J/(kg-K)*103 K*0.115 kg=8308.73 J
Heat lost by Al plate=8308.73 J
Change in Al plate temperature=8308.73 J/[900 J/(kg-K)*2.038 kg]=4.53 K=4.53 C

Based on the above, in certain embodiments, the heater plate may be adjusted by 4.53° C. (e.g., to 129.53° C.) to compensate for the extra energy needed to bring the Si wafer to the same temperature as the heater plate. This calculation assumes that the heater plate is off during this transition period and that the transition period is short enough to neglect heat losses to the environment. However, cold wafer compensation offset values may be estimated including the effects of heating air around the heater plate and wafer, and other objects in close proximity in accordance with the invention, if desired. Further, the transient time necessary for the heater transfer may be considered if desired.

Comparison of Control Scheme with Integral Memory and Without:

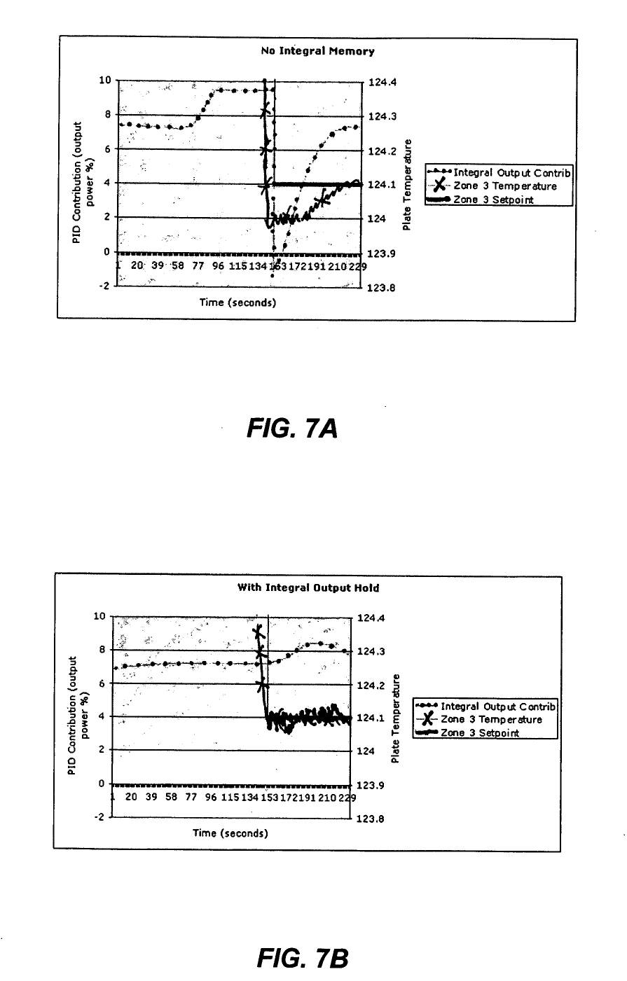

In another example, comparisons are shown between control schemes with no integral memory (FIG. 7A) and with integral memory (FIG. 7B). As shown, when the PID is reactivated with no integral memory, it takes approximately 60 seconds to stabilize. In contrast, with integral memory, the temperature zone stabilizes essentially instantaneously. The overshoot is 4 times smaller, and settling time also approximately 4 times faster.

The examples and embodiments described herein are for illustrative purposes only. Various modifications or changes in light thereof will be suggested to persons skilled in the art and are to be included within the spirit and purview of this application and scope of the appended claims. It is not intended that the invention be limited, except as indicated by the appended claims.

What is claimed is:

1. A control unit for controlling the temperature of a heater plate of a semiconductor processing thermal unit, the control unit comprising a control module interfaced with a heater plate of a semiconductor processing thermal unit, wherein the control module is configured to implement a temperature control scheme including cold wafer temperature compensation,
the temperature control scheme including:
controlling the heater plate temperature based on a desired heater plate temperature setpoint plus a predetermined cold wafer compensation offset value;
turning off control upon placement of a semiconductor wafer on the heater plate until the temperature of the heater plate reaches the desired heater plate temperature setpoint;
reinstating control and controlling the heater plate temperature at the desired heater plate temperature setpoint for a desired duration of time.

2. The control unit of claim 1, wherein the temperature control scheme comprises integral action and further includes:
retaining the integral contribution value of the control scheme prior to placement of the semiconductor wafer, and reinstating the same integral contribution value when control is turned back on to control at the desired heater plate temperature setpoint.

3. The control unit of claim 2, wherein the integral contribution value is retained based on the value attained during steady state control of the desired heater plate temperature setpoint without the cold wafer compensation offset value.

4. The control unit of claim 2, wherein the control unit is configured to obtain steady state temperature control of the heater plate at the desired heater plate temperature setpoint following placement of a semiconductor wafer in less than about 60 seconds.

5. The control unit of claim 1, wherein the temperature control scheme comprises:
an initial state of Proportional-Integral-Derivative (PID) control at a desired heater plate temperature setpoint plus a predetermined cold wafer compensation offset value based on a compensation value for the average temperature difference between the heater plate temperature setpoint and the initial temperature of a semiconductor wafer that is to be heated by the heater plate;
a first trigger point at a time point based upon contact of a semiconductor wafer to the heating plate, which initializes switch-two and switch-three, wherein switch-two prompts the control module to turn off PID control to the heater plate while retaining the integral contribution in memory and wherein switch-three prompts the control module to retain the output power contribution in memory and to manually set the output power of the control module for the heater plate to the retained value times a predetermined scaling factor;
a second trigger point at a time point based on when the heater plate temperature reaches the desired temperature setpoint plus an optional predetermined temperature drift offset, which resets switch-two and switch-three so as to prompt the control module to turn PID control on with the retained integral contribution value and to switch the output power back from manual, and further initializes switch-one, wherein switch-one prompts the control module to remove the predetermined cold wafer compensation offset value from the desired temperature setpoint of the heater plate;
a third trigger point at a time based on when the semiconductor wafer is removed from the heater plate, which again initializes switch-two so as to prompt the control module latch the integral contribution value to substantially result in PD control with some offset power;
a fourth trigger point at a time after the semiconductor wafer is removed from the heater plate, which resets switch-one so as to prompt the control module to reinstate the predetermined cold wafer compensation offset value to the desired temperature setpoint of the heater plate; and
a fifth trigger point at a time after the heater plate temperature reaches the desired temperature setpoint, plus the predetermined cold wafer compensation offset value, plus an optional predetermined temperature drift offset, which resets switch-two so as to prompt the control module to reset the integral contribution value to result in PID control.

6. The control unit of claim 1, wherein the control unit is control module is interfaced with a multizone heater plate having at least two heating zones, and wherein the control module independently controls at least two zones of the heater plate.

7. A lithography track tool comprising:
a semiconductor processing thermal unit including a heather plate interfaced with a control unit for controlling the temperature of the heater plate, which control unit comprises a control module interfaced with the heater plate configured to implement a temperature control scheme including cold wafer temperature compensation;
wherein the temperature control scheme includes:
controlling the heater plate temperature based on a desired heater plate temperature setpoint plus a predetermined cold wafer compensation offset value;
turning off control upon placement of a semiconductor wafer on the heater plate until the temperature of the heater plate reaches the desired heater plate temperature setpoint;
reinstating control and controlling the heater plate temperature at the desired heater plate temperature setpoint for a desired duration of time.

8. The lithography track tool of claim 7, wherein the temperature control scheme comprises integral action and further includes:
retaining the integral contribution value of the control scheme prior to placement of the semiconductor wafer, and reinstating the same integral contribution value when control is turned back on to control at the desired heater plate temperature setpoint.

9. The lithography track tool of claim 8, wherein the integral contribution value is retained based on the value attained during steady state control of the desired heater plate temperature setpoint without the cold wafer compensation offset value.

10. The lithography track tool of claim 8, wherein the control unit is configured to obtain steady state temperature control of the heater plate at the desired heater plate temperature setpoint following placement of a semiconductor wafer in less than about 60 seconds.

11. The lithography track tool of claim 7, wherein the control unit is control module is interfaced with a multizone heater plate having at least two heating zones, and wherein the control module independently controls at least two zones of the heater plate.

12. A method for controlling the temperature of a heater plate of a semiconductor processing thermal unit, the method comprising:
providing a heater plate interfaced with a control unit, wherein a desired heater plate temperature setpoint plus a predetermined cold wafer compensation offset value based on a compensation value for the average temperature difference between the heater plate temperature setpoint and the initial temperature of a semiconductor wafer that is to be heated by the heater plate is provided to the control unit;
controlling the heater plate temperature based on a desired heater plate temperature setpoint plus a predetermined cold wafer compensation offset value with the control unit;
turning off control upon placement of a semiconductor wafer on the heater plate until the temperature of the heater plate reaches the desired heater plate temperature setpoint;
reinstating control and controlling the heater plate temperature at the desired heater plate temperature setpoint for a desired duration of time.

13. The method of claim 12, wherein the control unit comprises integral action, and the method further includes retaining the integral contribution value of the control unit prior to placement of the semiconductor wafer, and reinstating the same integral contribution value when control is turned back on to control at the desired heater plate temperature setpoint.

14. The method of claim 13, wherein the integral contribution value is retained based on the value attained during steady state control of the desired heater plate temperature setpoint without the cold wafer compensation offset value.

15. The method of claim 13, wherein steady state temperature control of the heater plate at the desired temperature setpoint following placement of a semiconductor wafer is obtained in less than about 60 seconds.

16. The method of claim 12, wherein said method comprises:
providing a heater plate interfaced with a control unit having integral action configured to control the temperature of the heater plate;
providing a desired temperature setpoint plus a predetermined cold wafer compensation offset value based on a compensation value for the average temperature difference between the heater plate temperature setpoint and the initial temperature of a semiconductor wafer that is to be heated by the heater plate;
heating the heater plate to the desired temperature setpoint plus the predetermined cold wafer compensation offset value;
placing a semiconductor wafer on the heater plate after the heater plate has reached the desired temperature setpoint plus predetermined cold wafer compensation offset value;
switching off the control unit, wherein the integral contribution and the output power contribution are retained in memory in the control unit;
manually setting the output power contribution of the control unit to the retained value times a predetermined scaling factor;
allowing the heater plate to reach the desired setpoint temperature plus an optional predetermined temperature drift offset;
removing the predetermined cold wafer compensation offset value from the temperature setpoint of the control unit;
switching on the control unit, wherein the retained integral contribution is utilized by the control unit and the output power contribution is switched off of manual;
allowing the control unit to control the temperature of the heater plate at the desired temperature setpoint for a desired amount of time;
removing the semiconductor wafer from the heater plate after a desired amount of time;
latching the integral contribution of the control unit so as to provide substantial PD control with power offset;
providing the predetermined cold wafer compensation offset value to the temperature setpoint of the control unit, and allowing the heater plate to heat to the desired temperature setpoint plus the predetermined cold wafer compensation offset value;
switching on the integral contribution of the control unit after the heater plate has reached the desired temperature setpoint plus predetermined cold wafer compensation offset value.

17. The method of claim 12, wherein the heater plate is a multizone heater plate having at least two heating zones, and at least two zones of the heater plate are independently controlled according to said method.
